(19) United States
(12) Patent Application Publication
(10) Pub. No.: US 2026/0228498 A1
(43) Pub. Date: Aug. 6, 2026

(54) SYSTEMS AND METHODS FOR PERFORMING PREDICTION TASKS FROM TABULAR DATA USING A HIERARCHICAL SET OF ENCODER MACHINE LEARNING MODELS

(71) Applicant: The Toronto-Dominion Bank, Toronto (CA)

(72) Inventors: George Frazer STEIN, Port Coquitlam (CA); Keyu LONG, Toronto (CA); Xin NING, Toronto (CA); Michelle Erica LEVINE, Toronto (CA); Saba ZUBERI, Toronto (CA); Maksims VOLKOVS, Toronto (CA)

(21) Appl. No.: 19/345,509

(22) Filed: Sep. 30, 2025

Related U.S. Application Data
(60) Provisional application No. 63/752,448, filed on Jan. 31, 2025.

(51) Int. Cl. G06N 3/0455; G06N 3/088

(52) U.S. Cl. CPC G06N 3/0455; G06N 3/088

(57) ABSTRACT

Systems and methods for performing one or more prediction task. The methods comprise: receiving a hierarchical set of encoder machine learning models configured to convert one or more tabular datasets into a token that represents the one or more tabular datasets; pre-training the hierarchical set of encoder machine learning models using self-supervised learning to generate a pre-trained hierarchical set of encoder machine learning models; fine-tuning a predictive model to perform one or more prediction task using supervised learning, the predictive model comprising a prediction head for each prediction task, each prediction head configured to generate a prediction for the corresponding prediction task based on the token generated by the pre-trained hierarchical set of encoder machine learning models; and processing one or more new tabular datasets using the fine-tuned predictive model to generate a prediction for each prediction task.

### CROSS-REFERENCE TO RELATED APPLICATION

The present application claims priority to U.S. Provisional Patent Application No. 63/752,448, filed on Jan. 31, 2025, and titled “SYSTEMS AND METHODS FOR PERFORMING PREDICTION TASKS FROM TABULAR DATA USING A HIERARCHICAL SET OF ENCODER MACHINE LEARNING MODELS”, the entire contents of which are hereby incorporated by reference.

### TECHNICAL FIELD

The disclosed example embodiments relate to computer-implemented methods and systems for performing one or more tabular prediction tasks using a hierarchical set of encoder machine learning models.

### BACKGROUND

Machine learning models can be used to perform prediction tasks (e.g., event prediction) in a variety of industries including, but not limited to, healthcare, education, manufacturing, energy and utilities, technology and cybersecurity, real estate and construction, transportation and logistics, education, and hospitality and travel.

Traditionally performing a prediction task using a machine learning model comprises curating, engineering and/or selecting features from the available data that are relevant for performing the prediction task and training, using historical data, a machine learning model to make a prediction based on the selected features. For example, to predict whether a pump in a production line will fail in the next 10 days, an engineer and/or data scientist may identify the average daily vibration measurement at the pump and the average hourly temperature data at the pump over a historical window to be relevant in determining whether the pump will fail. A machine learning model may then be trained, for example, using a labelled data set of the average daily vibration and average hourly temperature over the historical window for pumps that failed and did not fail, to receive average daily vibration information and hourly temperature information over the historical window and predict whether the pump will fail in the next 10 days.

Thus, traditionally, when there is a plurality of prediction tasks, features are curated, engineered and/or selected for each prediction task and a different model is trained for each prediction task. However, curating, engineering and/or selecting features for each of a plurality of prediction tasks and training a separate model therefore is both labour and time intensive and requires significant computing resources to store each model.

### SUMMARY

The following summary is intended to introduce the reader to various aspects of the detailed description, but not to define or delimit any invention.

A first aspect provides a system for performing one or more prediction task, the system comprising at least one processor configured to: receive a hierarchical set of encoder machine learning models configured to convert one or more tabular datasets into a token that represents the one or more tabular datasets; pre-train the hierarchical set of encoder machine learning models using self-supervised learning to generate a pre-trained hierarchical set of encoder machine learning models; fine-tune a predictive model to perform the one or more prediction task using supervised learning, the predictive model comprising a prediction head for each of the one or more prediction task, each prediction head configured to generate a prediction for the corresponding prediction task based on the token generated by the pre-trained hierarchical set of encoder machine learning models; and process one or more new tabular datasets using the fine-tuned predictive model to generate a prediction for the one or more prediction task.

Pre-training the hierarchical set of encoder machine learning models using self-supervised learning may comprise training the hierarchical set of encoder machine learning models to generate one or more element of the one or more tabular datasets from other elements of the one or more tabular datasets.

The one or more element of the one or more tabular datasets may be identified by a mask.

Each tabular dataset of the one or more tabular datasets may comprise data related to a same historical time period.

Pre-training the hierarchical set of encoder machine-learning models using self-supervised learning may comprise training the hierarchical set of encoder machine learning models to generate one or more elements of one or more second tabular datasets that comprise data related to a next historical time period.

The one or more tabular datasets may comprise a plurality of tabular datasets and the hierarchical set of encoder machine learning models may comprise: a plurality of first layer encoder machine learning models configured to generate, for each tabular dataset in the plurality of tabular datasets, one or more intermediate token that represents that tabular dataset; and a second layer encoder machine learning model that is configured to generate the token from the intermediate tokens generated by the plurality of first layer encoder machine learning models.

The plurality of first layer encoder machine learning models may comprise, for each different type of tabular dataset in the plurality of tabular datasets, a first layer encoder machine learning model that is configured to generate the one or more intermediate token for each tabular dataset in the plurality of tabular datasets of that type.

Each tabular dataset of the plurality of tabular datasets may comprise data related to a same historical time period, the historical time period is sub-divided into a plurality of sub-time periods, and the one or more intermediate token that represents a tabular dataset may comprise an intermediate token for each of the plurality of sub-time periods that represents data in the tabular dataset related to that sub-time period.

The historical time period may comprise a 12-month period, and the plurality of sub-time periods may comprise a sub-time period for each month of the 12-month period.

Each intermediate token may be a same size.

At least one first layer encoder machine learning model of the plurality of first layer encoder machine learning models may comprise a multi-layer perceptron neural network.

At least one first layer encoder machine learning model of the plurality of first layer encoder machine learning models may comprise an encoder-only transformer model.

The token may comprise a multi-element vector.

Each element of the multi-element vector may comprise a floating-point number.

The multi-element vector may comprise 128 elements.

Each tabular dataset of the one or more tabular datasets may comprise time series data.

At least one of the one or more prediction task may comprise predicting a future event.

The prediction head for at least one of the one or more prediction task may comprise a multi-layer perceptron neural network.

A second aspect provides a method for performing one or more prediction task, the method executed in a computing environment comprising at least one processor, the method comprising: receiving a hierarchical set of encoder machine learning models configured to convert one or more tabular datasets into a token that represents the one or more tabular datasets; pre-training the hierarchical set of encoder machine learning models using self-supervised learning to generate a pre-trained hierarchical set of encoder machine learning models; fine-tuning a predictive model to perform the one or more prediction task using supervised learning, the predictive model comprising a prediction head for each of the one or more prediction task, each prediction head configured to generate a prediction for the corresponding prediction task based on the token generated by the pre-trained hierarchical set of encoder machine learning models; and processing a plurality of new tabular datasets using the fine-tuned predictive model to generate a prediction for the one or more prediction task.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic diagram illustrating using one machine learning model per prediction task;

FIG. 2 is a schematic diagram illustrating using one machine learning model to perform multiple prediction tasks;

FIG. 3 is a block diagram of an example system for performing one or more prediction tasks using a predictive foundation model that comprises a hierarchical set of encoder machine learning models;

FIG. 4 is a block diagram of an example implementation of the cloud-based computing cluster of FIG. 3 configured to perform one or more prediction tasks using a predictive foundation model that comprises a hierarchical set of encoder machine learning models;

FIG. 5 is a block diagram of an example implementation of the hierarchical set of encoder machine learning models;

FIG. 6A is a schematic diagram illustrating a first example method of performing self-supervised learning of a foundation model;

FIG. 6B is a schematic diagram illustrating a second example method of performing self-supervised learning of a foundation model.

FIG. 7 is a block diagram of an example implementation of the predictive foundation model of FIG. 4 configured to perform an example set of prediction tasks;

FIG. 8 is a flow diagram of a first example method for performing a set of prediction tasks;

FIG. 9 is a flow diagram of a second example method for performing a set of prediction tasks;

FIG. 10 is a flow diagram of a third example method for performing a set of prediction tasks;

FIG. 11 is a flow diagram of a fourth example method for performing a set of prediction tasks; and

FIG. 12 is a block diagram of an example computer which may be used to implement all or a portion of the system of FIG. 3, the cloud-based computing cluster of FIG. 4 and/or any of the methods of FIGS. 8 to 11.

### DETAILED DESCRIPTION

The term “prediction task” is used herein to mean forecasting or estimating an outcome based on input data. Prediction tasks include, but are not limited to, classification tasks (e.g., predicting a categorical label or class from input data, such as, but not limited to, predicting the presence or absence of a disease based on patient data); regression tasks (e.g., predicting a continuous numerical value based on input data, such as, but not limited to, predicting the price of a house based on features like, size, location, number of rooms, etc.), time series forecasting tasks (e.g., predicting future values based on past data that is collected over time, such as, but not limited to, predicting the amount of traffic on roads based on historical traffic data and patterns), and anomaly detection (e.g., predicting whether a data point is normal or anomalous, such as predicting whether a financial transaction is fraudulent or not).

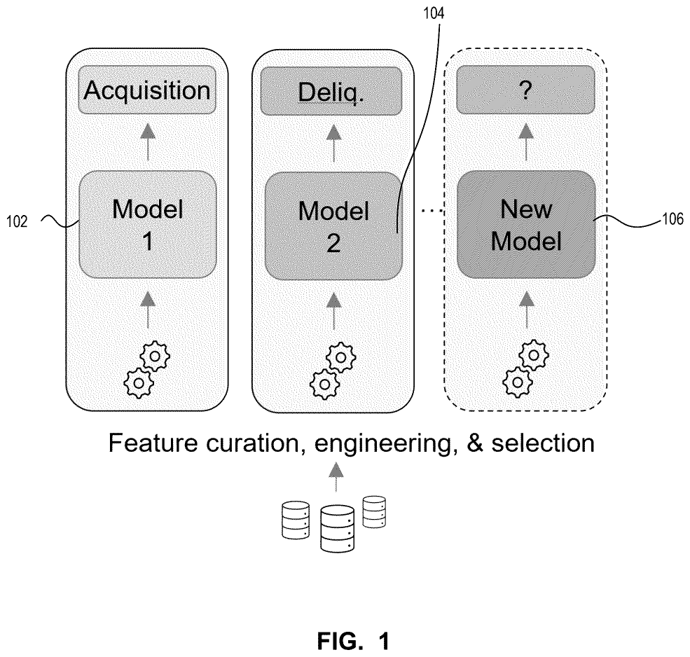

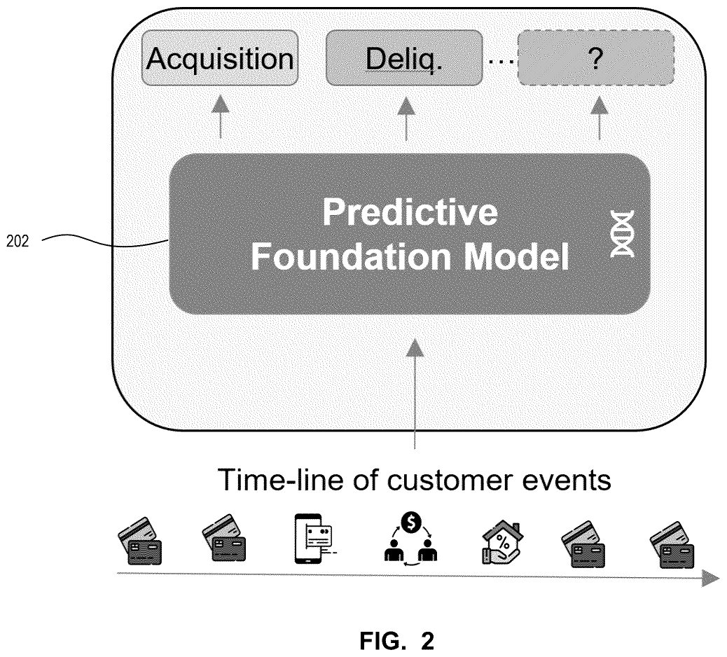

As described above, traditionally to perform a plurality of prediction tasks, features are curated, engineered and/or selected from the available data for each prediction task and a different model is trained for each prediction task. For example, as shown in FIG. 1, there may be one machine learning model 102 trained to predict, from a first set of features curated from customer data, whether a customer will acquire a product (e.g., a credit card) within a predetermined period, another machine learning model 104 trained to predict, from a second set of features curated from the customer data, whether a customer will be delinquent with respect to a product (e.g., credit card) within a predetermined period, and yet another trained machine learning model 106 to perform another customer-related prediction task based on a third set of features curated from the customer data. However, curating, engineering and/or selecting features for each of a plurality of prediction tasks and training a separate model therefore is both labour and time intensive and requires significant computing resources to store each model.

Where the features for each of a plurality of prediction tasks are drawn from the same raw data (e.g., the same raw data for a customer or object), it would be desirable to, instead of having to curate, engineer and/or select individual features from the raw data and train individual machine learning models thereon, have one machine learning model that can receive the raw data and perform the plurality of prediction tasks on the raw data. For example, as shown in FIG. 2, it would be desirable to have a single model 202 that can receive raw data (e.g., for an entity or object) that can perform the prediction tasks shown in FIG. 1.

A machine learning model that can perform (or be fine-tuned to perform) a plurality of prediction tasks may be referred to as a predictive foundation model. Predictive foundation models may be implemented by a transformer architecture. Examples of transformer-based predictive foundation models include, but are not, limited to: large language models (LLMs), such as GPT (Generative Pre-trained Transformer), which are designed to perform natural language processing (NLP) (i.e., understand and generate human-like text based on the input they receive), and ViTs (Vision Transformers) which is designed for image processing tasks, such as image classification, object detection, and segmentation. However, while transformer-based predictive foundation models for processing text and images have been developed, there are many instances where raw data may be stored in tabular form (i.e., as a set of rows and columns) and specifically, in multiple different tables.

Accordingly, described herein are transformer-based predictive foundation models that are configured to process raw tabular datasets, and computing systems and methods for using such models to perform one or more prediction tasks. Specifically, described herein are predictive foundation models that comprise (1) a hierarchical set of encoder machine learning models which are configured to receive a plurality of tabular datasets, wherein each tabular dataset comprises data related to the same time period (e.g., each tabular data relates to the same 12-month period), and process the plurality of tabular datasets using the hierarchical set of encoder machine learning models to generate a token that represents the plurality of tabular datasets; and (2) a prediction head for each of one or more prediction tasks wherein each prediction head is configured to generate a prediction target for the corresponding prediction task based on the token generated by the hierarchical set of encoder machine learning models.

In some cases, the hierarchical set of encoder machine learning models comprises: a plurality of first layer encoder machine learning models configured to generate, for each of the plurality of tabular datasets, one or more intermediate tokens that represent that tabular dataset; and a second layer (e.g., transformer) encoder machine learning model that is configured to generate the final token based on the intermediate tokens generated by the first layer encoder machine learning models.

In some cases, the predictive foundation model is trained to perform the one or more prediction tasks by training the hierarchical set of encoder machine learning models and the prediction head(s) together using supervised learning. In other cases, the predictive foundation model is trained to perform the one or more prediction tasks by first training the hierarchical set of encoder machine learning models using self-supervised learning and then fine-tuning the hierarchical set of encoder machine learning models and the prediction head(s) using supervised learning.

The transformer-based predictive foundation models described herein have shown a significant performance enhancement over classic machine learning and statistical methods (e.g., XGBoost-based models) in performing a variety of prediction tasks. Furthermore, since the transformer-based predictive foundation models described herein operate on raw data, data scientists, developers and/or engineers do not have to engineer input features from the raw data for each prediction task. Not only does this save significant time and investment in engineering the features, developing the model and validating the model for each prediction task, but it may also improve the performance of the model. Specifically, engineering summary features from a large rich raw data set inherently loses information compared to the raw data itself and deciding which features to create/exclude requires domain expertise, which can both negatively impact model performance.

Finally, as described in more detail below, rather than building customized models for each prediction task, a single transformer-based predictive foundation model described herein can simultaneously predict a large number of events. This can reduce the time and resources required to develop, train, and test each of the different models. Furthermore, new predictions can be built on an already existing model. This can significantly reduce the development time to generate a model for a new prediction task.

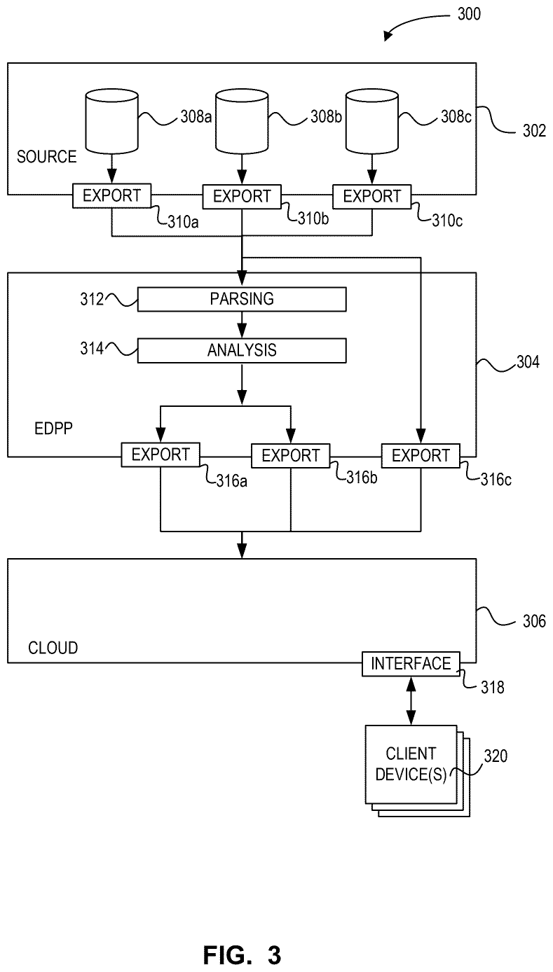

Reference is now made to FIG. 3, which illustrates a block diagram of an example computing system 300 for performing one or more prediction tasks on tabular data. Computing system 300 comprises a source database system 302, an enterprise data provisioning platform (EDPP) 304 operatively coupled to the source database system 302, and a cloud-based computing cluster 306 that is operatively coupled to the EDPP 304.

Source database system 302 has one or more databases, of which three are shown for illustrative purposes: database 308a, database 308b and database 308c. One or more of the databases of the source database system 302 may contain confidential information that is subject to restrictions on export. One or more export modules 310a, 310b, 310c may periodically (e.g., daily, weekly, monthly, etc.) export data from the databases 308a, 308b, 308c to the EDPP 304. In some instances, the data is exported on an ad hoc basis.

EDPP 304 receives source data exported by the export modules 310a, 310b, 310c of source database system 302, processes it and exports the processed data to an application database within the cloud-based computing cluster 306. For example, a parsing module 312 of EDPP 304 may perform extract, transform and load (ETL) operations on the received source data.

In many environments, access to the EDPP may be restricted to relatively few users, such as administrative users. However, with appropriate access permissions, data may be exported via reporting and analysis module 314 or an export module 316a, 316b, 316c. In particular, parsed data can then be processed and transmitted to the cloud-based computing cluster 306 by a reporting and analysis module 314. Alternatively, one or more export modules 316a, 316b, 316c can export the parsed data to the cloud-based computing cluster 306.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 304 may “de-risk” data tables that contain confidential data prior to transmission to cloud-based computing cluster 306. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 306 is configured to receive a plurality of tabular datasets from the EDPP 304 and process the plurality of tabular datasets using a predictive foundation model to perform one or more prediction tasks. The cloud-based computing cluster 306 includes an interface 318, which facilitates data communication with one or more client devices 320.

In some environments, the EDPP may be omitted. In such cases the cloud-based computing cluster 306 may receive the data, for processing by the predictive foundation model, directly from the source database system 302.

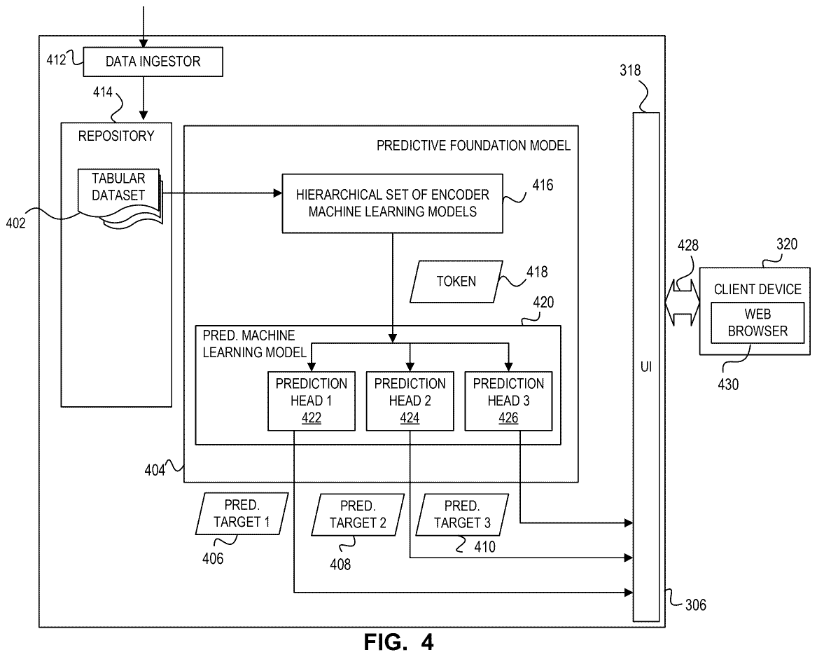

Reference is now made to FIG. 4, which illustrates an example implementation of the cloud-based computing cluster 306 of FIG. 3. As described above, the cloud-based computing cluster 306 is configured to receive a plurality of tabular datasets 402 and process the plurality of tabular datasets using a predictive foundation model 404 to perform one or more prediction tasks. Specifically, processing the plurality of tabular datasets using the predictive foundation model 404 causes the predictive foundation model 404 to generate a prediction target 406, 408, 410 for each of the one or more predictions tasks.

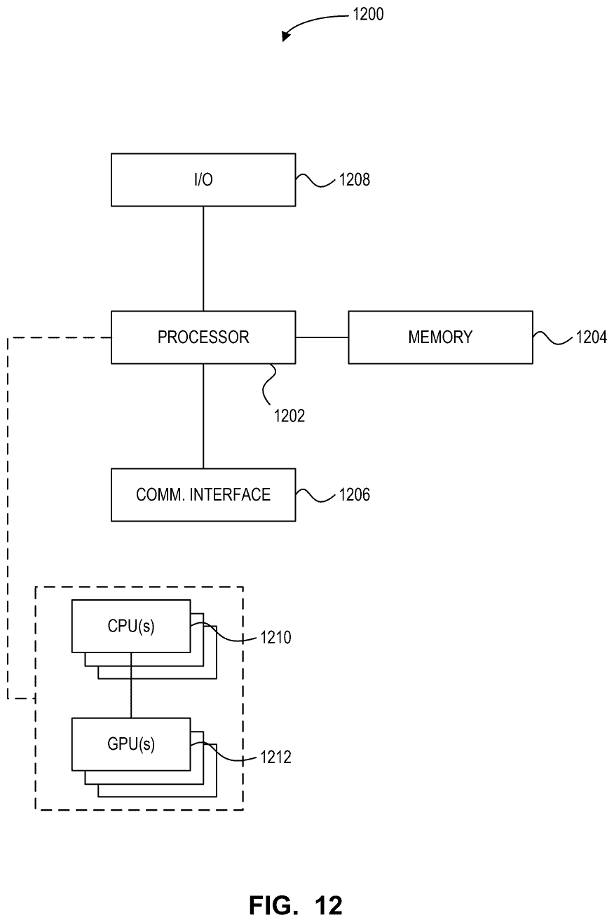

In some cases, one or more components of the cloud-based computing cluster 306 may be implemented by one or more computers within the cloud-based computing cluster, such as, but not limited to, computer 1200 described below with respect to FIG. 12. In some cases, one or more components of the cloud-based computing cluster 306 may be implemented as virtual machines within the cloud-based computing cluster 306.

The term “tabular dataset” is used herein to mean a set of data that is arranged into rows and columns. In some cases, each row may be referred to as an entry of the tabular dataset and the data at each (row, column) position may be referred to as an element of the tabular dataset. Each tabular dataset 402 comprises data related to the same historical time period. For example, each tabular dataset may comprise data that relates to the same 12-month period. However, this is just an example and in other examples the tabular datasets may relate to a different time period (e.g., a month, two years etc.). In some cases, one or more of the tabular datasets 402 may comprise time-series data. The term time series data is used herein to mean a series of data points with a time identifier which may or may not be arranged in time/date order. In other words, time series data is data that is time-stamped. In some cases, the plurality of tabular datasets may comprise data at different cadences. For example, one or more tabular datasets may comprise data at a monthly level, one or more tabular datasets may comprise data at daily level, and/or one or more tabular datasets may comprise data at an hourly or minute level.

In some cases, each tabular dataset of the plurality of tabular datasets may comprise different information about the same entity (e.g., customer or object). For example, as described in more detail below, if the entity is a customer of a financial institution, one tabular dataset may comprise all the transactions in the historical time period for a first financial account (e.g., a chequing account), another tabular dataset may comprise all the transactions in the historical time period for a second, different, financial account (e.g., a credit card account), and yet another tabular dataset may comprise customer data such as summary information about a customer's portfolio at the financial institution. An example of the plurality of tabular datasets which may represent data for a customer of a financial institution are described below. In some cases, at least two of the tabular datasets of the plurality of tabular datasets may comprise a different number of columns and/or a different number of rows. In some cases, one or more of the tabular datasets may have a variable number of entries.

In some cases, the plurality of tabular datasets may be received from the source database system 302 or the EDPP 304 via, for example, a data ingestor 412. In some cases, the plurality of tabular datasets may be provided directly to the predictive foundation model 404. However, in other cases, the plurality of tabular datasets 402 may be first stored in a repository 414 and then provided to the predictive foundation model 404. The repository 414 is any mechanism or device, such as, but not limited to, memory, that is capable of storing digital information.

The predictive foundation model 404 is a deep learning neural network that is configured to process the plurality of tabular datasets 402 to generate a prediction target 406, 408, 410 for each of one or more prediction tasks. As described above, a prediction task is forecasting or estimating an outcome based on input data. Prediction tasks include, but are not limited to, classification tasks (e.g., predicting a categorical label or class from input data, such as, but not limited to, predicting the presence or absence of a disease based on patient data); regression tasks (e.g., predicting a continuous numerical value based on input data, such as, but not limited to, predicting the price of a house based on features like, size, location, number of rooms, etc.), time series forecasting tasks (e.g., predicting future values based on past data that is collected over time, such as, but not limited to, predicting the amount of traffic on roads based on historical traffic data and pattern), and anomaly detection (e.g., predicting whether a data point is normal or anomalous, such as predicting whether a financial transaction is fraudulent or not). The predicted outcome for a prediction task is referred to herein as the prediction target.

In the example shown in FIG. 4 the predictive foundation model 404 is configured to perform three prediction tasks (i.e., configured to generate three prediction targets 406, 408, 410). However, this is just an example and in other examples the predictive foundation model 404 may be configured to perform fewer or more prediction tasks. The format of a prediction target 406, 408, 410 will depend on the prediction task. For example, if the prediction task is a classification task, such as predicting the presence or absence of a disease, then the prediction target may comprise a binary output for each class being predicted. In contrast, if the prediction task is a regression task, such as predicting the price of a house, then the prediction target may be a numerical value. When the predictive foundation model 404 is configured to perform a plurality of prediction tasks, the prediction targets 406, 408, 410 may all have the same format or two or more of the prediction targets may have different formats.

The predictive foundation model 404 of FIG. 4 comprises a hierarchical set of encoder machine learning models 416 that are configured to convert the plurality of tabular datasets into a single token 418 that represents the plurality of tabular datasets; and a predictor machine learning model 420 that is configured to generate a prediction target 406, 408, 410 for each of one or more prediction tasks from the token 418 generated by the hierarchical set of encoder machine learning models 416. Thus, the predictive foundation model 404 of FIG. 4 can perform multiple prediction tasks based on the same input data (i.e., same plurality of tabular datasets 402) in parallel or simultaneously. The hierarchical set of encoder machine learning models 416 may be considered to implement the feature extraction stage of the predictive foundation model 404 and the predictor machine learning model 420 may be considered to implement the prediction stage of the predictive foundation model.

As noted above, the hierarchical set of encoder machine learning models 416 is configured to convert the plurality of tabular datasets 402 into a single token 418 that represents the plurality of tabular datasets 402. An encoder machine learning model is a machine learning model that is configured to take input data and transform it into a compressed, fixed-length representation, essentially extracting the key features and meaning from the input. Various neural networks architectures can be used to implement an encoder machine learning model. Examples of neural network architectures which can be used to implement an encoder machine learning model include, but are not limited to, a multi-layer perceptron (MLP) neural network and an encoder-only transformer. In some cases, all of the encoder machine learning models in the hierarchical set of encoder machine learning models 416 may be implemented by the same neural network architecture and in other cases two or more of the encoder machine learning models in the hierarchical set of encoder machine learning model 416 may be implemented by different neural network architectures. As described in more detail below, in some cases the neural network architecture used to implement an encoder may depend on the data that the encoder machine learning model is to process.

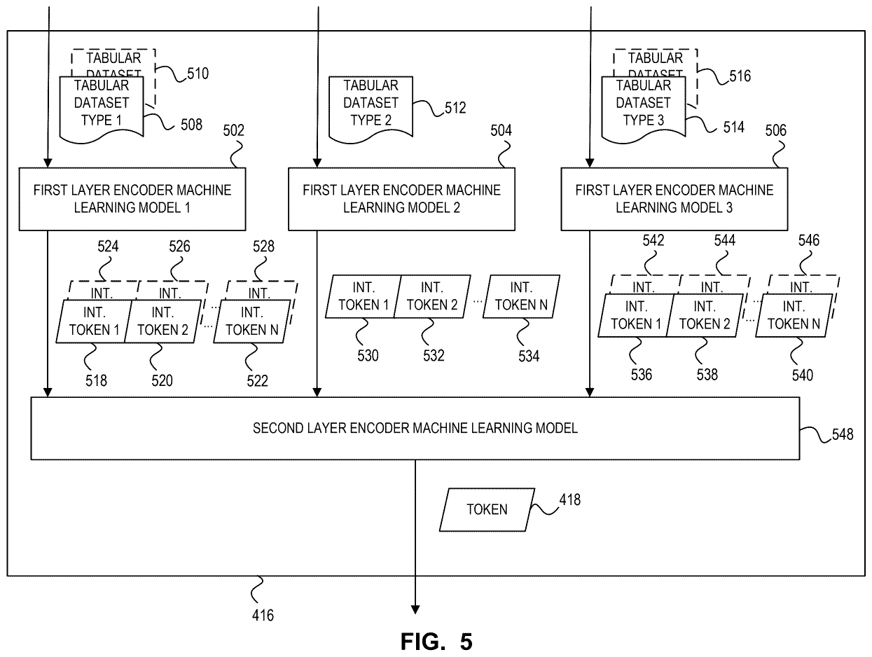

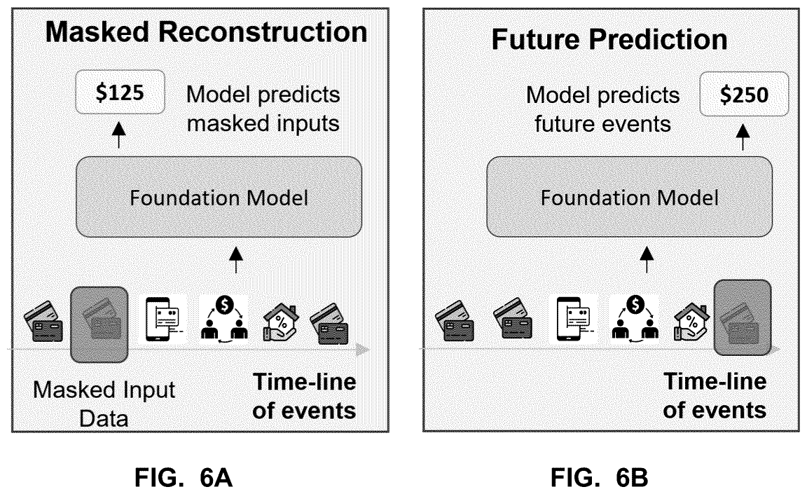

The hierarchical set of encoder machine learning models 416 comprises a plurality of encoder machine learning models arranged in a hierarchy. Specifically, the plurality of encoder machine learning models is divided into a hierarchy of layers wherein the output of an encoder machine learning model of a higher layer becomes an input to an encoder machine learning model of a lower layer. In some cases, as described in more detail below with respect to FIG. 5, the hierarchical set of encoder machine learning models 416 may comprise a first layer encoder machine learning model for each different tabular dataset type in the plurality of tabular datasets that is configured to generate, for each tabular dataset of that type, a set of one or more intermediate token that represent that tabular dataset; and a second layer encoder machine learning model that is configured to generate the final token 418 from the sets of one or more intermediate token generated by the first layer encoder machine learning models.

For example, if the plurality of tabular datasets 402 comprises: (1) a tabular dataset that comprises all the transactions for a first credit card account for a customer over the time period; (2) a tabular dataset that comprises all the transactions for a second credit card account for the customer over the time period; and (3) a tabular dataset that comprises account balance information for a chequing account for the time period, then there may be a first layer encoder machine learning model that is configured to receive and process credit card transaction tabular datasets (e.g. tabular datasets (1) and (2)) and a different first layer encoder machine learning model that is configured to receive and process account balance information for a chequing account (e.g., tabular dataset (3)). Thus, the first layer encoder machine learning models convert each of the plurality of tabular datasets 402 into a standard format which is used by the second layer encoder machine learning model to generate the final token 418.

In some cases, each token (e.g., the final token 418 and each intermediate token), which also may be referred to as an embedding, may be a multi-element vector. In some cases, where each token is a multi-element vector, each element may be a floating-point value. In some cases, where each token is a multi-element vector, the multi-element vector may comprise 128 elements. However, these are just examples, and a token may have a different number of elements, and the elements may be in a different format.

An example implementation of the hierarchical set of encoder machine learning models 416 is described below with respect to FIG. 5.

As noted above, the predictor machine learning model 420 is configured to generate a prediction target 406, 408, 410 for each of one or more prediction tasks from the token 418 generated by the hierarchical set of encoder machine learning models 416. In some cases, as shown in FIG. 4, the predictor machine learning model 420 comprises a prediction head 422, 424 and 426 for each of the one or more prediction task that the predictive foundation model is to perform. Each prediction head 422, 424, 426 is configured to generate the prediction target 406, 408, 410 for the corresponding prediction task based on the token 418 generated by the hierarchical set of encoder machine learning models 416. The example predictive foundation model 404 of FIG. 4 is configured to perform three prediction tasks, thus there are three prediction heads 422, 424, 426. However, this is just an example, and in other examples the predictive foundation model 404 may be configured to perform more or fewer prediction tasks and thus may have more or fewer prediction heads.

Each prediction head 422, 424, 426 is a neural network that comprises a (e.g., small) set of layers, responsible for generating a prediction target 406, 408, 410 based on the features extracted by the hierarchical set of encoder machine learning models 415. In other words, each prediction head 422, 424, 426 transforms the token 418 (which represents the key features of the tabular datasets) into the desired output format, like a class label for classification or a continuous value for regression. A prediction head, such as the prediction heads 422, 424, 426 of FIG. 4, may be implemented by a variety of different neural network architectures. An example of a neural network architecture that may be used to implement a prediction head 422, 424 or 426 comprises, but is not limited to, a MLP neural network.

In some cases, each prediction target 406, 408, 410 generated by the predictive foundation model 404 is provided to a client device 320 that is connected over a data communication link 428 to the user interface 318. For example, each prediction target 406, 408, 410 may be provided to the client device 320 via a web browser 430 or some other application that operates on the client device 320.

### Hierarchical Set of Encoder Machine Learning Models

As described above, the hierarchical set of encoder machine learning models 416 is configured to convert the plurality of tabular datasets into a single token 418 that represents the plurality of tabular datasets. Reference is now made to FIG. 5 which illustrates an example implementation of the hierarchical set of encoder machine learning models 416 of FIG. 4. In the example shown in FIG. 5, the hierarchical set of encoder machine learning models 416 comprises a plurality of first layer encoder machine learning models 502, 504, 506 that are configured to convert each of the received tabular datasets 508, 510, 512, 514, 516 into a plurality of intermediate tokens 518, 520, 522; 524, 526, 528; 530, 532, 534; 536, 538, 540; 542, 544, 546 that represent the tabular dataset 508, 510, 512, 514, 516; and a second layer encoder machine learning model 548 that is configured to convert the intermediate tokens 518, 520, 522; 524, 526, 528; 530, 532, 534; 536, 538, 540; 542, 544, 546 into a single token 418 that represents the plurality of tabular datasets.

In some cases, the plurality of tabular datasets comprises a plurality of different types of tabular datasets and there may be a first layer encoder machine learning model 502, 504, 506 for each different type of dataset in the plurality of tabular datasets. Tabular datasets that have similar types of data may be said to be of the same type and tabular datasets that have different types of data may be said to be of a different type. The different types of tabular datasets in the plurality of tabular datasets will depend on the application in which the predictive foundation model is used. For example, where the plurality of tabular datasets comprise data for a customer of a financial institution, then a tabular dataset that comprises transaction data for a credit card account may be of one type and a tabular dataset that comprise transaction data for a demand account (e.g., a chequing account) may be of a different type. In the example shown in FIG. 5 the plurality of tabular datasets comprises three different types of tabular datasets, thus there are three different first layer encoder machine learning models 502, 504, 506. However, this is an example only and in other examples the plurality of tabular datasets may comprise fewer or more different types of tabular datasets.

Where there is a first layer encoder machine learning model 502, 504, 506 for each different type of dataset in the plurality of tabular datasets, each first layer encoder machine learning model 502, 504, 506 is configured to convert each tabular dataset 508, 510, 512, 514, 516 of the corresponding type to a plurality of intermediate tokens 518, 520, 522; 524, 526, 528; 530, 532, 534; 536, 538, 540; 542, 544, 546 that represent the tabular dataset 508, 510, 512, 514, 516. For example, in FIG. 5, if there are two type 1 tabular datasets 508, 510 then the corresponding first layer encoder machine learning model 502 is configured to generate a plurality of intermediate tokens 518, 520, 522 for the first type 1 tabular dataset 508 that represents the features of the first type 1 tabular dataset 508, and a plurality of intermediate tokens 524, 526, 528 for the second type 1 tabular dataset 510 that represents the features of the second type 1 tabular dataset 510. By having a different first layer encoder machine learning model for each different type of tabular dataset, each first layer encoder machine learning model can be trained to learn to extract the important or relevant features from that type of tabular dataset.

In some cases, each intermediate token 518, 520, 522; 524, 526, 528; 530, 532, 534; 536, 538, 540; 542, 544, 546 may be the same size and/or have the same format and each first layer encoder machine learning model 502, 504, 506 may be configured to generate the same number of intermediate tokens per tabular dataset. For example, each first layer encoder machine learning model 502, 504, 506 may be configured to generate N intermediate tokens per tabular dataset wherein N is an integer greater than one. In this manner, the first layer encoder machine learning models 502, 504, 506 are configured to convert each input tabular dataset 508, 510, 512, 514, 516 into the same format.

As described above, each tabular dataset processed by the hierarchical set of encoder machine learning models 416 comprises data related to the same historical time period (e.g., the same 12-month period). In some cases, the historical time period is sub-divided into a plurality of sub-time periods, and each first layer encoder machine learning model is configured to generate an intermediate token 518, 520, 522; 524, 526, 528; 530, 532, 534; 536, 538, 540; 542, 544, 546 for each of the plurality of sub-time periods that represents the data in the corresponding tabular dataset that relates to that sub-period. For example, in some cases, the historical time period may be a 12-month period. In these cases, the historical time period may be sub-divided into months such that there is an intermediate token for each month (e.g., an intermediate token for January, an intermediate token for February, and so on). This is an example only and in other examples, the historical time period may be a smaller or larger time period and/or the historical time period may be sub-divided into sub-time periods in another manner.

Various neural networks architectures can be used to implement an encoder machine learning model. Examples, of neural network architectures which can be used to implement an encoder machine learning model include, but are not limited to, a multi-layer perceptron (MLP) neural network and an encoder-only transformer. In some cases, all of the first layer encoder machine learning models 502, 504, 506 may be implemented by the same neural network architecture and in other cases the first layer encoder machine learning models 502, 504, 506 may be implemented by a variety of different neural network architectures.

In some cases, the neural network architecture used to implement a first layer encoder machine learning model 502, 504, 506 may depend on the type of data that the first layer encoder machine learning model 502, 504, 506 is to process. Specifically, in some cases, if a first layer encoder machine learning model 502, 504, 506 is configured to process a, relatively, small tabular dataset with a fixed size (e.g., a fixed number of rows and columns) then a simpler neural network architecture, such as, but not limited to, an MLP neural network may be used to implement that first layer encoder machine learning model 502, 504, 506. Specifically, MLPs are simple feed-forward networks with fully connected layers which can efficiently extract features from smaller data volume. In contrast, if a first layer encoder machine learning model 502, 504, 506 is configured to process a larger dataset that has a variable length (e.g., a variable number of entries) then a more complicated neural network architecture, such as, but not limited to, an encoder only transformer may be used to implement that first layer encoder machine learning model. An encoder only transformer uses, instead of feed-forward layers, self-attention mechanisms which make it better suited to variable length input sequences and allows it to capture long-range dependencies in sequential data.

For example, where the tabular datasets comprise data for a customer of a financial institution, one tabular dataset may comprise a fixed-size customer summary dataset which comprises, for each month in the historical time period, a high level summary of the customer's products with the financial institution such as, but not limited to, total money in and total money out of active accounts; and another tabular dataset may comprise all the transactions for the customer's credit card over the historical time period. Since the customer summary tabular dataset is relatively small and has a fixed-size it may be beneficial to process that tabular dataset using a small encoder neural network, such as, but not limited to, an MLP; and since the credit card transaction tabular dataset could be large and is variable in length, it may be beneficial to process that tabular dataset using a more complicated encoder neural network such as, but not limited to, an encoder-only transformer.

In some cases, the hierarchical set of encoder machine learning models 416 may be configured to receive a fixed number (D) of tabular datasets. However, in some cases, the number of tabular datasets from which the one or more prediction tasks are to be performed may comprise less than D tabular datasets. For example, the hierarchical set of encoder machine learning models 416 may be configured to receive 16 tabular datasets that comprise a tabular dataset that comprises transactions in the historical time period for a first credit card and a tabular dataset comprising transactions in the historical time period for a second credit card. If a customer only has one credit card, then there will not be a tabular dataset comprising transactions in the historical time period for a second credit card. In such cases, the plurality of tabular datasets may be padded to account for any missing tabular datasets prior to being processed by the hierarchical set of encoder machine learning models 416. For example, a tabular dataset representing the transactions in the historical time period for the second credit card may be generated that is all zeros and the all zero tabular dataset may be provided to the hierarchical set of encoder machine learning models 416 for processing.

The second layer encoder machine learning model 548 is configured to generate, from the intermediate tokens 518, 520, 522; 524, 526, 528; 530, 532, 534; 536, 538, 540; 542, 544, 546, a single token 418 that represents the plurality of tabular datasets. In some cases, the second layer encoder machine learning model 548 is implemented by a large neural network, such as, but not limited to, an encoder-only transformer. Instead of relying on traditional recurrent or convolutional neural networks, transformers harness the power of self-attention mechanisms to capture relationships and dependencies within sequences. This allows transformers to excel in tasks that require context, coherence, and understanding across diverse elements of a sequence. A transformer generally comprises one or more encoders which tokenize an input and one or more decoders which use the tokens to generate an output sequence. Encoder-only transformers are a specialized variant of the transformer architecture, focusing solely on the task of understanding and encoding input sequences as tokens. The focus of an encoder-only transformer is to extract meaningful context from the input.

In some cases, to allow the second layer encoder machine learning model 548 to distinguish intermediate tokens from different data sources and/or that relate to different sub-time periods (e.g., different months), markers (e.g., implemented as learnable positional embeddings) may be added to the intermediate tokens. For example, in some cases, a family marker, an index marker, and a time index marker may be added to each intermediate token before it is forwarded to the second layer encoder machine learning model. Family type markers are shared within the same family and differ between families or categories (e.g., customer, credit card account, demand account etc.) For example, all data that relates to a credit card may have the same family marker. Index markers separate different entities within the same family. For example, different credit cards would have different index markers). Time markers indicate the time period the token relates to. For example, where the sub-time periods are months, the time marker may identify the relative month gap between the month the data relates to and the target prediction date.

### Training the Predictive Foundation Model

In some cases, when the predictive foundation model 404 is to perform a fixed set of prediction tasks, the hierarchical set of encoder machine learning models 416 may be trained in conjunction with the predictor machine learning model 420 (e.g., that comprises a prediction head 422, 424, 464 for each prediction task in the set of prediction tasks) using supervised learning. Supervised learning is the technique of using labeled data to train a machine learning model to identify underlying patterns between input features and outputs. The objective of supervised learning is to generate a model that can predict correct outputs on new input data. Labelled training data consists of a plurality of datapoints which comprises an example set of inputs and the correct outputs for that set of inputs. To train the predictive foundation model 404 described herein, each datapoint would comprise an example set of tabular datasets and the correct output for each prediction task of the set of prediction tasks for that set of tabular datasets. The datapoints are fed into the model and the outputs of the model are compared to the correct outputs (via a loss function) and the parameters of the model are adjusted, using an algorithm, such as, but not limited to, a gradient descent algorithm, to minimize the loss function. Training the predictive foundation model 404 in this manner trains the hierarchical set of encoder machine learning models 416 to extract the features from the plurality of tabular datasets that are most relevant to the prediction tasks and encode those features in the token.

In other cases, when the predictive foundation model is to perform a fixed set of prediction tasks, the hierarchical set of encoder machine learning models 416 may be first pre-trained using self-supervised learning. Then, the pre-trained hierarchical set of encoder machine learning models 416 in conjunction with the predictor machine learning model 420 may be fine-tuned via supervised learning to be optimized for a particular set of prediction tasks.

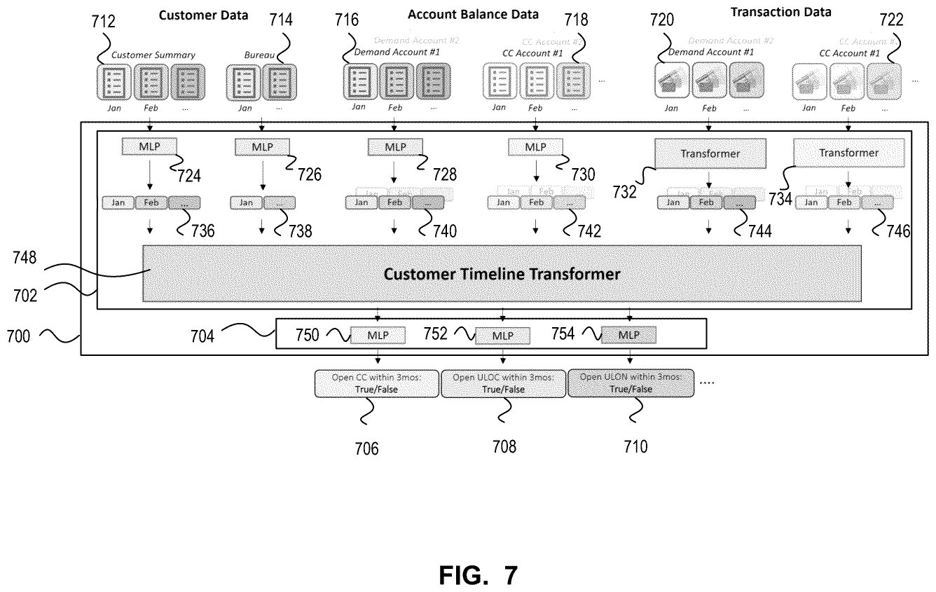

Self-supervised learning (SSL) is a technique for training a model on unlabeled data where the data labels are generated automatically—i.e., the labels are inherent in the data itself instead of being manually added. SSL may be implemented by training the SSL to perform one or more pretext task where a pre-text task is a self-supervised object that the model will try to solve in order to learn useful representations (e.g., learn to extract and encode important features). In some cases, in SSL the pretext task may be predicting missing parts of the input. For example, as shown in FIG. 7A, the hierarchical set of encoder machine learning models 416 may be trained to predict one or more masked inputs. More specifically, the hierarchical set of encoder machine learning models 416 may be trained to predict one or more masked elements of a tabular dataset, one or more masked entries of a tabular dataset, or one or more masked tabular datasets based on the other inputs.

In other cases, the pretext task may comprise predicting one or more future events. For example, as shown in FIG. 7B, the training data may comprise data for multiple historical time periods—i.e., a plurality of tabular datasets for a first 12 month period and a plurality of tabular datasets for a second 12 month period- and the hierarchical set of encoder machine learning models may be trained to receive the plurality of tabular datasets that correspond to one historical time period (e.g. one 12 month period) and predict one or more elements of a tabular dataset in the next historical time period (e.g., another 12 month period), one or more entries in a tabular dataset in the next historical time period, or one or more whole tabular datasets in the next historical time period.

A model, such as the hierarchical set of encoder machine learning models 416, can be trained to perform a pretext task in the same manner that a model is trained via supervised learning—e.g., by comparing the output generated in response to the input to the ground truth or correct output using, for example, a loss function, and adjusting the parameters of the encoder machine learning models in the hierarchical set of encoder machine learning models 416 to minimize the loss function using, for example, an algorithm such as, but not limited to, gradient descent. Where the pretext task is generating masked out data of the input, then the masked out data from the original input acts as the ground truth or correct output, and where the pretext task is generating input data for a future time period, the data from the future time period acts as the ground truth or correct output.

Pre-training the hierarchical set of encoder machine learning models 416 using SSL trains the hierarchical set of encoder machine learning models to extract the most important features of the plurality of tabular datasets, generally, and encode those features. In other words, the important features that are identified via SSL are not tied to a specific downstream prediction task or set of prediction tasks. The harder the pretext tasks, the better the hierarchical set of encoder machine learning models learns the important features. Also, the larger the training dataset the better the hierarchical set of encoder machine learning models 416 learns the important features. Pre-training the hierarchical set of encoder machine learning models 416 using SSL results in a hierarchical set of encoder machine learning models that is well-suited to a wide range of down-stream prediction tasks without tying it to any specific set of prediction tasks.

Once the hierarchical set of encoder machine learning models 416 has been pre-trained using SSL, the pre-trained hierarchical set of encoder machine learning models 416 can be fine-tuned in conjunction with the predictor machine learning model 420 for a specific set of prediction tasks using supervised fine tuning (SFT) to optimize the performance of the predictive foundation model for that specific set of prediction tasks. SFT comprises training a model on labeled data, so the model learns to predict the correct output for each input. However, since the model has been pre-trained already, the amount of labeled data (e.g., the number of labelled datapoints) to adequately fine-tune the model for a set of prediction tasks using SFT can be significantly less than the amount of labeled data (e.g., the number of labelled datapoints) to adequately train a model from scratch.

Once a hierarchical set of encoder machine learning models 416 has been trained either via SSL or as part of a predictive foundation model to perform a specific set of prediction tasks, the trained hierarchical set of encoder machine learning models 416 can be connected to any number of prediction heads to perform any number of prediction tasks in parallel.

### Example Tabular Datasets

In some cases, the predictive foundation model may be configured to make one or more predictions for customers of a financial institution based on raw customer data held by that financial institution. In such cases, the plurality of tabular datasets 402 processed by the predictive foundation model 404 may comprise one or more categories of tabular datasets. For example, the plurality of tabular datasets 402 may comprise one or more customer tabular datasets, one or more account tabular datasets, and/or one or more transaction tabular datasets.

A customer tabular dataset may comprise general information about the customer and their portfolio at the financial institution. In some cases, there may be a customer summary tabular dataset that includes a monthly or bi-monthly summary of the customer's portfolio with the financial institution that includes information such as, but not limited to, the total money out of all active accounts at the financial institution; and/or a customer credit bureau tabular dataset that includes credit bureau information about the customer to provide information about broader holdings and risks.

An account tabular dataset may comprise summary information at the account level for a specific account which may include information such as, but not limited to, general balances (e.g., end of cycle credit balance) and basic details about the account (e.g., interest paid). In some cases, there may be an account balance tabular dataset for each demand, credit card, line of credit (LOC), loan, mortgage, and investment account that the customer holds. For example, if the customer has a demand account (e.g., a chequing account) and two credit card accounts with the financial institution, there may be three account balance tabular datasets for that customer-one for the demand account, and one for each of the credit card accounts.

A transaction tabular dataset may comprise a record of all the transactions over the historical period for a specific account. In some cases, there may be an account balance tabular dataset for each demand, credit card, line of credit (LOC), loan, mortgage, and investment account that the customer holds. For example, if the customer has a demand account (e.g., a chequing account) and two credit card accounts with the financial institution, there may be three transaction tabular datasets for that customer-one for the demand account, and one for each of the credit card accounts.

This is simply an example of a set of plurality of tabular datasets that may be processed by a predictive foundation model described herein and in other examples a predictive foundation model described herein may be configured to process different tabular datasets.

### Example Predictive Foundation Model for Example Use Case

Reference is now made to FIG. 7 which illustrates an example implementation of the predictive foundation model described above that is configured to receive raw data about a customer of a financial institution and generate a prediction of whether the customer will acquire a set of unsecured credit products (credit card, unsecured line of credit (ULOC) or unsecured loan (ULON)) within a predetermined period (e.g., within 3 months from the date of inference excluding a one month buffer).

The example predictive foundation model 700 of FIG. 7 comprises a hierarchical set of encoder machine learning models 702 that is configured to receive a plurality of tabular datasets and generate a single token that represents the plurality of tabular datasets and a predictor machine learning model 704 that is configured to generate a prediction target 706, 708, 710 for each of the three prediction tasks. Specifically, the predictor machine learning model 704 generates a first prediction target 706 that indicates whether it is likely that the customer will open a credit card account within the next three months, a second prediction target 708 that indicates whether it is likely that the customer will open a ULOC account within the next three months, and a third prediction target 710 that indicates whether it is likely that the customer will open a ULON account within the next three months.

The plurality of tabular datasets each comprise data within a historical period (e.g., the preceding 12-month window) that relate to the customer. In this example, each tabular data set is a time series tabular dataset such that each entry in a tabular dataset has a date/timestamp associated therewith. In the example shown in FIG. 7, the plurality of tabular datasets comprises a plurality of customer datasets 712, 714; a plurality of account balance datasets 716, 718; and a plurality of transaction datasets 720, 722. The plurality of customer datasets comprises a customer summary tabular dataset 712 and a customer bureau tabular dataset 714. The plurality of account balance datasets comprises an account balance tabular dataset for each demand, credit card, line of credit (LOC), loan, mortgage, and/or investment account that the customer holds. For example, as shown in FIG. 7, there may be a demand account balance tabular dataset 716 for each demand account that the customer has, a credit card account balance tabular dataset 718 for each credit card account that the customer has etc. The plurality of transaction datasets comprises a transaction tabular dataset for each demand, credit card, line of credit (LOC), loan, mortgage, and/or investment account that the customer holds. Each of these tabular datasets were described above. For readability not all of the tabular datasets that are received at, and processed by, the predictive foundation model 700 are shown in FIG. 7.

The hierarchical set of encoder machine learning models 702 comprises a set of first layer encoder machine learning models 724, 726, 728, 730, 732, 734 that are configured to generate, for each received tabular dataset 712, 714, 716, 718, 720, 722 a set of intermediate tokens 736, 738, 740, 742, 744, 746, that represent that tabular dataset; and a second layer encoder machine learning model 748 that is configured to generate, from the intermediate tokens generated by the first layer encoder machine learning models, a final token that represents all of the received tabular datasets 712, 714, 716, 718, 720, 722.

In the example of FIG. 7, there is a first layer encoder machine learning model for each different type of tabular dataset that the predictive foundation model 700 is configured to process. Datasets that are in the same category (e.g., customer, account, transaction) and relate to the same type of account are the same type; otherwise, they are different types. For example, two transaction tabular datasets that relate to different credit cards are of the same type, but a transaction tabular dataset that is related to a credit card is a different type of tabular dataset from a transaction tabular dataset that is related to a demand account.

Accordingly, as shown in FIG. 7, there is an encoder machine learning model for processing each type of customer dataset (e.g., an encoder machine learning model 724 for processing customer summary tabular datasets and an encoder machine learning model 726 for processing customer bureau tabular datasets), an encoder machine learning model for processing each type of account balance dataset (e.g., an encoder machine learning model 728 for processing demand account balance tabular datasets, an encoder machine learning model 730 for processing credit card account balance tabular datasets etc.); and an encoder machine learning model for process each type of transaction tabular dataset (e.g., an encoder machine learning model 732 for processing demand transaction tabular datasets, an encoder machine learning model 734 for processing credit card transaction tabular datasets etc.). For readability, not all of the first layer encoder machine learning models are shown in FIG. 7.

In the example, shown in FIG. 7, each first layer encoder machine learning model 724, 726, 728, 730, 732, 734 is configured to generate, for each processed tabular dataset, a token for each month of the year that represents the data in the tabular dataset that relates to that month. For example, the encoder machine learning model 724 configured to process customer summary tabular datasets is configured to generate a token (e.g., vector) for January that represents the customer summary information for January, a token (e.g., vector) for February that represents the customer summary information for February etc.; and the encoder machine learning model 734 configured to process credit card transaction tabular datasets is configured to generate, for each credit card transaction tabular dataset it receives, a token (e.g. vector) for January that represents all the transactions (or all the activity) on that credit card in January, a token (e.g., a vector) for February that represents all the transactions (or all the activity) on that credit card in February etc. In some cases, the tabular datasets received and processed by the predictive foundation model 700 may have a table for each month that comprises the data for that month.

In the example shown in FIG. 7 the encoder machine learning models 724, 726, 728, 730 configured to process customer or account balance tabular datasets are implemented by a MLP, and the encoder machine learning models 732, 734 configured to process transaction tabular datasets are implemented by a transformer, and specifically an encoder-only transformer. This is because MLPs are simple feed-forward networks with fully connected layers that are efficient for small data volumes like the customer and account balance tabular datasets; and the self-attention mechanisms implemented by transformers make them better suited to variable length input sequences like transaction tabular datasets which have a variable number of transactions. Transformers can also capture long-range dependencies in sequential data.

As described above, the second layer encoder machine learning model 748 is configured to receive the intermediate tokens 736, 738, 740, 742, 744 and 746 generated by the first layer encoder machine learning models 724, 726, 728, 730, 732, 734, and generate a single token (e.g., vector) that represents all of the data in the input tabular datasets. In the example shown in FIG. 7, the second layer encoder machine learning model 748 is implemented by an encoder-only transformer and thus may be referred to as a “Customer Timeline Transformer”.

As described above, the predictor machine learning model 704 is configured to generate, from the token, a prediction target 706, 708, 710 for each prediction task. Specifically, the predictor machine learning model 704 generates a first prediction target 706 that indicates whether it is likely that the customer will open a credit card account within the next three months, a second prediction target 708 that indicates whether it is likely that the customer will open a ULOC account within the next three months, and a third prediction target 710 that indicates whether it is likely that the customer will open a ULON account within the next three months. In the example shown in FIG. 7, the predictor machine learning model 704 comprises a prediction head 750, 752, 754 for each prediction task that is configured to process the token generated by the second layer encoder machine learning model 748 to generate the prediction target 706, 708, 710 for that prediction task. Specifically, there is a first prediction head 750 to perform the credit card prediction, a second prediction head 752 to perform the ULOC prediction, and a third prediction head 754 to perform the ULON prediction. In the example shown in FIG. 7, each prediction head is implemented by an MLP.

As shown in Table 1 below, the performance of the predictive foundation model 700 shown in FIG. 7 was assessed over a wide variety of statistical metrics (e.g., positive rate, PRAUC, ROCAUC, top decile lift, recall @10%) for an OOT (out-of-time) test set on each of the prediction tasks. Each metric demonstrated high model performance across the entire OOT test periods and continuously outperformed known models, such as custom XGBoost models, configured to perform the three prediction tasks.

TABLE 1

| | Credit Card | ULOC Prediction | ULOAN Prediction |
|---|---|---|---|
| | Prediction Task | Task | Task |
| Positive Rate | 0.0066 | 0.0022 | 0.0009 |
| PRAUC | 0.0405 | 0.0207 | 0.0259 |
| ROCAUC | 0.726 | 0.890 | 0.964 |
| Top Decile Lift | 5.11 | 6.25 | 5.99 |
| Recall@10% | 0.511 | 0.625 | 0.599 |

### Other Example Use Cases

The predictive foundation models described above can be used in a variety of industries including, but not limited to, healthcare, education, manufacturing, energy and utilities, technology and cybersecurity, real estate and construction, transportation and logistics, education, hospitality, and travel, and financial.

The following are example prediction tasks, related to a customer of a financial institution, which the predictive foundation models described herein may be configured to perform based a plurality of tabular datasets related to that customer, such as the example tabular datasets described above. The predictive foundation models described herein may be configured to perform any combination of the following prediction tasks.

Specifically, in some cases, the predictive foundation models described herein may be configured to perform one or more financial product acquisition predictions—i.e., predict whether a customer will apply for, or request, a financial product (or a change to a financial product) within a predetermined time in the future (e.g., within the next three months). The prediction generated in response to such a prediction task may be used, for example, to determine whether to target the entity (e.g., individual or business/enterprise) for marketing of that financial product. Examples of financial products for which the predictive foundation models described herein may be configured to predict the acquisition thereof include, but are not limited to, a credit card (CC), unsecured line of credit (ULOC), unsecured loan (ULOAN), real estate secured lending (RESL), direct investing account, wealth account, chequing account, savings account, term life policy, overdraft protection, trade account, travel medical insurance policy, balance protection insurance, mutual funds, guaranteed investment certificates (GICs), term deposits and mortgages with another financial institution.

In some cases, a predictive foundation model described herein may configured to not only predict whether a customer will acquire a specific product, like a credit card, but the type of that product. For example, the predictive foundation models described herein maybe configured to predict not only whether a customer will acquire a credit card within a predetermined period, but the type of credit card. The following are examples of different credit types that may be predicted: Aeroplan® Infinite, Aeroplan® Infinite Privilege, Aeroplan® Platinum, Cash Back Entry, Cash Back Infinite, First Class Travel, low rate, platinum travel, or rewards credit card. Similarly, in some cases, a predictive foundation model described herein may be configured to not only predict whether a customer will acquire a chequing account, but the currency of that chequing account—e.g., whether the chequing account will be in Canadian dollars or US dollars. Similarly, in some cases, a predictive foundation model described here may be configured to not only predict whether a customer will acquire a mutual fund, but also the type of mutual fund—e.g., whether the mutual fund is registered or non-registered. Similarly, in some cases, a predictive foundation model described herein may be configured to not only predict whether a customer will acquire a GIC and/or term deposit within a predetermined period, but the type of GIC or term deposit—e.g., whether the GIC term deposit is registered or non-registered. Similarly, in some cases, a predictive foundation model described herein may be configured to not only predict whether a customer will acquire an investing account, but the type of account—e.g., whether the investing account is a TFSA (Tax-Free Savings Account), RRSP (Registered Retirement Savings Plan), other registered account, or a non-registered account.

In some cases, the predictive foundation models described herein may also, or alternatively, be configured to predict financial product attrition—e.g., whether the customer will cancel or close a financial product within a predetermined period. An attribution prediction may be used by the financial product provider to proactively contact the customer to persuade them to keep, or continue with, the product. Examples of financial products for which the predictive foundation models described herein may be configured to predict the attrition thereof include, but are not limited to, a credit card (CC), unsecured line of credit (ULOC), unsecured loan (ULOAN), direct investing account, wealth account, chequing account, savings account, mortgage, home equity line of credit (HELOC), mutual fund, guaranteed investment certificate (GIC), and term deposit.

In some cases, the predictive foundation models described herein may also, or alternatively, be configured to predict whether, a customer will become delinquent with respect to a financial product. A delinquency prediction may be used determine whether the financial product provider is to provide the financial product to the entity. Examples of financial products for which the predictive foundation models described herein may be configured to predict the delinquency thereof include, but are not limited to, a credit card (CC), unsecured line of credit (ULOC), unsecured loan (ULOAN), and real estate secured lending (RESL).

In some cases, the predictive foundation models described herein may also, or alternatively, be configured to predict fraudulent activity with respect to a financial product. In these cases, the prediction may be used to take proactive action such as, for example, re-issuing a new credit card for an CC account which has been identified as being at risk for fraudulent use. For example, the predictive foundation models described herein may be configured to detect the risk or likelihood of an account being fraudulently taken over, the risk or likelihood of mule fraud for an account (i.e., the risk that an entity moves or transfers ill-gotten funds via the account), or the risk or likelihood of an account being used for money laundering. In another example, the predictive foundation models described herein may also, or alternatively, be configured to predict that an application for a financial product (e.g., CC) is fraudulent, and/or there has been an account breach (e.g., a fraudulent transaction) on a CC or a debit account.

In some cases, the predictive foundation models described herein may also, or alternatively, be configured to predict whether a customer is likely to acquire credit protection for a financial product. Examples of financial products for which the predictive foundation models described above may be configured to predict whether a customer is likely to obtain credit protection for include, but are not limited to, a credit card, ULOAN, ULOC, HELOC and mortgage.

In some cases, the predictive foundation models described herein may also, or alternatively, be configured to predict features or events related to a financial product. For example, the predictive foundation models describe herein may be configured to predict ULOC utilization, HELOC utilization, a credit limit decrease and/or cash flow management (e.g., estimated money in/money out) for an account, future account actions such as, but not limited to recurring bill payment, e-bills etc. The predictive foundation models described herein may also, or alternatively, be configured to predict the following with respect to a credit card: whether there will be a transfer of the balance to another credit card (and the balance that will be transferred), whether the customer will qualify for a credit limit increase, whether the card will be downgraded, whether the customer will make a preauthorized payment, and/or whether the card will be upgraded. The predictive foundation models described herein may also, or alternatively, be configured to predict the following with respect to a chequing account: whether the account will be upgraded or downgraded, whether the customer will be a pre-authorized debit, whether the customer will make a direct deposit, or whether the customer will request or require overdraft protection. The predictive foundation models described herein may also, or alternatively, be configured to predict a savings account balance increase. The predictive foundation models described herein may also, or alternatively, be configured to predict a mutual fund purchase, mutual fund pre-authorized purchase plan, an increase or RRSP contribution.

In some cases, the predictive foundation models described herein may also, or alternatively, be configured to predict one or more of a ULOC credit increase, a GIC or term deposit term renewal, whether the direct investing account that the customer obtains will be passive or active, and whether a customer will sign up for a credit card with a loyalty program.

### Methods

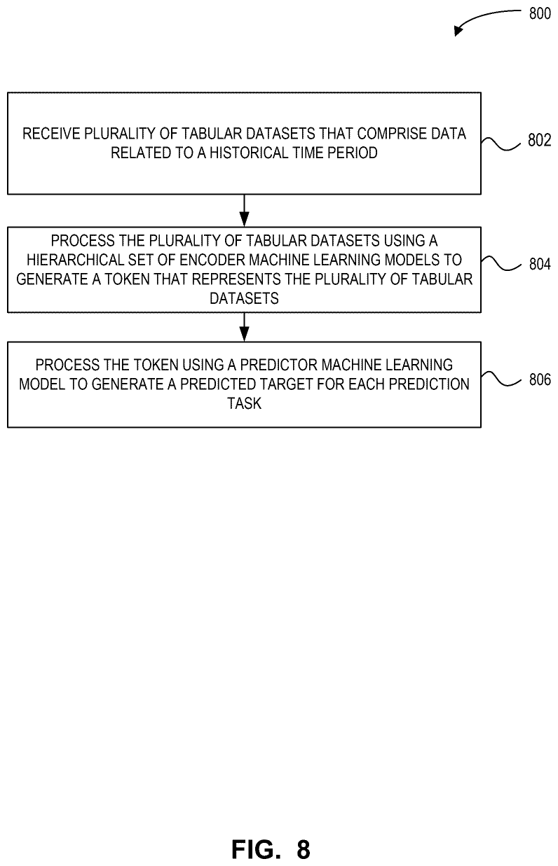

Reference is now made to FIG. 8 which illustrates a first example method 800 for performing one or more event prediction tasks on tabular data using a hierarchical set of encoder machine learning models. The method 800 begins at block 802 where a plurality of tabular datasets is received wherein each tabular dataset comprises data related to the same historical time period. Once the plurality of tabular datasets has been received, the method 800 proceeds to block 804 where the plurality of tabular datasets is processed using a hierarchical set of encoder machine learning models to generate a token that represents the plurality of tabular datasets. Once the token has been generated, the method 800 proceeds to block 806 where the token is processed using a predictor machine learning model to generate a predicted target for each of the one or more prediction task.

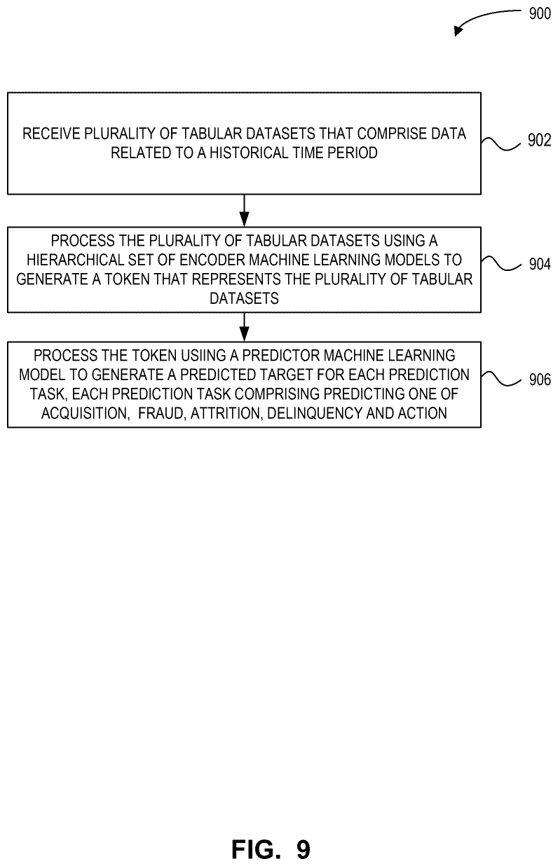

Reference is now made to FIG. 9 which illustrates a second example method 900 for performing one or more event prediction tasks on tabular data using a hierarchical set of encoder machine learning models. The method 900 begins at block 902 where a plurality of tabular datasets is received wherein each tabular dataset comprises data related to the same historical time period. Once the plurality of tabular datasets has been received, the method 900 proceeds to block 904 where the plurality of tabular datasets is processed using a hierarchical set of encoder machine learning models to generate a token that represents the plurality of tabular datasets, the hierarchical set of encoder machine learning models comprising a plurality of first layer encoder machine learning models configured to generate a plurality of intermediate tokens from the plurality of tabular datasets and a second layer encoder machine learning model configured to generate the token from the plurality of intermediate tokens. Once the token has been generated, the method 900 proceeds to block 906 where the token is processed using a predictor machine learning model to generate a predicted target for each of the one or more prediction task. In some cases, each of the one or more prediction task comprises prediction of one of acquisition, fraud, attrition, delinquency and action.

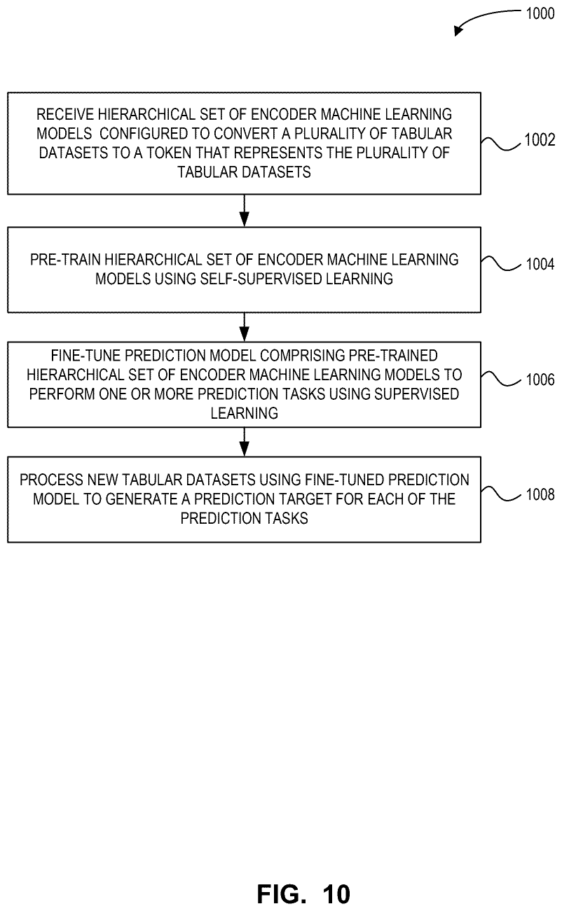

Reference is now made to FIG. 10 which illustrates a third example method 1000 for performing one or more event prediction tasks on tabular data using a hierarchical set of encoder machine learning models. The method 1000 begins at block 1002 where a hierarchical set of encoder machine learning models configured to convert a plurality of tabular datasets into a token that represents the plurality of tabular datasets is received. Once the hierarchical set of encoder machine learning models has been received, the method 1000 proceeds to block 1004 where the hierarchical set of encoder machine learning models is pre-trained using self-supervised learning to generate a pre-trained hierarchical set of encoder machine learning models. Once the hierarchical set of encoder machine learning models has been pre-trained, the method 1000 proceeds to block 1006 where a prediction model is fine-tuned to perform the one or more prediction task using supervised learning. The prediction model comprises the pre-trained hierarchical set of encoder machine learning models and a prediction head for each of the one or more prediction tasks. Each prediction head is configured to generate a prediction target for the corresponding prediction task based on the token generated by the pre-trained hierarchical set of encoder machine learning models. Once the prediction model has been fine-tuned, the method 1000 proceeds to block 1008 where a plurality of new tabular datasets is processed using the fine-tuned prediction model to generate a prediction target for each of the one or more prediction task.

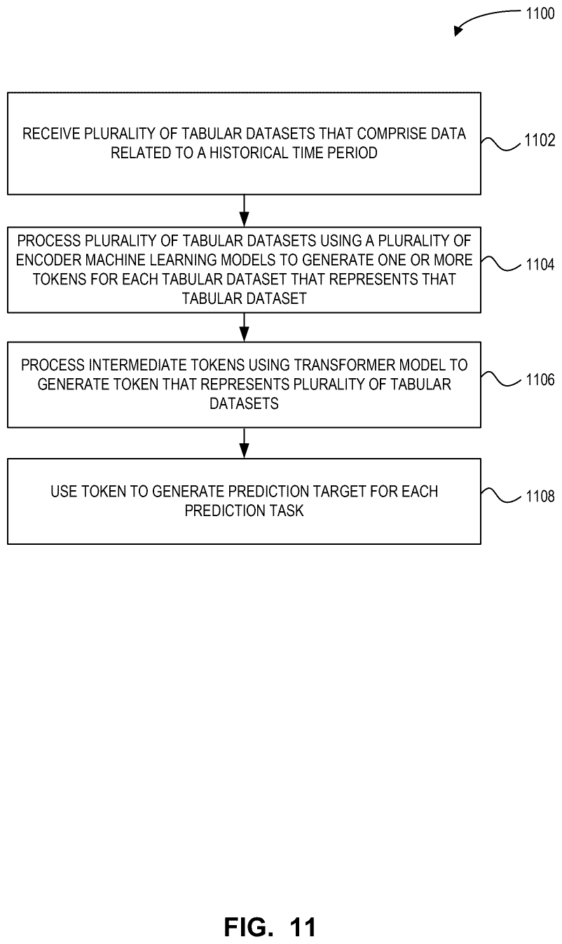

Reference is now made to FIG. 11 which illustrates a fourth example method 1100 for performing one or more event prediction tasks from tabular data using a hierarchical set of encoder machine learning models. The method 1100 begins at block 1102 where a plurality of tabular datasets is received wherein each tabular dataset comprises data related to a same historical time period. Once the plurality of tabular datasets is received, the method 1100 proceeds to block 1104 where the plurality of tabular datasets is processed using a plurality of encoder machine learning models to generate, for each tabular dataset in the plurality of tabular datasets, one or more intermediate token that represents that tabular dataset. Once the intermediate tokens have been generated, the method 1100 proceeds to block 1106 where the intermediate tokens generated by the encoder machine learning models are processed using a transformer model to generate a token that represents the tabular datasets. Once the token has been generated, the method 1100 proceeds to block 1108 where the token is used to generate a prediction target for each prediction task.

### Example Computer

Reference is now made to FIG. 12 which illustrates a simplified block diagram of an example computer 1200. Computer 1200 is an example implementation of a computer which may implement the source database system 302, EDPP 304, one or more components of the cloud-based computing cluster 306 of FIGS. 3 and 4 and/or any of the methods 800, 900, 1000, 1100 of FIGS. 8-11. Computer 1200 has at least one processor 1202 operatively coupled to at least one memory 1204, at least one communications interface 1206 (also referred to herein as a network interface), and at least one input/output (I/O) device 1208.

The at least one memory 1204 includes a volatile memory that stores instructions executed or executable by the processor 1202, and input and output data used or generated during execution of the instructions. The memory 1204 may also include non-volatile memory used to store input and/or output data—e.g., within a database—along with program code containing executable instructions.

The processor 1202 may transmit or receive data via the communications interface 1206 and may also transmit or receive data via any additional input/output device 1208 as appropriate.

In some cases, the processor 1202 includes a system of central processing units (CPUs) 1210. In other cases, the processor 1202 includes a system of one or more CPUs 1210 and one or more Graphical Processing Units (GPUs) 1212 that are coupled together. For example, any combination of the predictive foundation models 404, hierarchical set of encoder machine learning models 416, predictor machine learning models 420, and prediction heads 422, 424, 426 described herein may execute neural network computations on CPU and GPU hardware, such as the system of CPUs 1210 and GPUs 1212 of FIG. 12.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for performing one or more prediction task, the system comprising at least one processor configured to:
receive a hierarchical set of encoder machine learning models configured to convert one or more tabular datasets into a token that represents the one or more tabular datasets;
pre-train the hierarchical set of encoder machine learning models using self-supervised learning to generate a pre-trained hierarchical set of encoder machine learning models;
fine-tune a predictive model to perform the one or more prediction task using supervised learning, the predictive model comprising a prediction head for each of the one or more prediction task, each prediction head configured to generate a prediction for the corresponding prediction task based on the token generated by the pre-trained hierarchical set of encoder machine learning models; and
process one or more new tabular datasets using the fine-tuned predictive model to generate a prediction for the one or more prediction task.

2. The system of claim 1, wherein pre-training the hierarchical set of encoder machine learning models using self-supervised learning comprises training the hierarchical set of encoder machine learning models to generate one or more element of the one or more tabular datasets from other elements of the one or more tabular datasets.

3. The system of claim 2, wherein the one or more element of the one or more tabular datasets is identified by a mask.

4. The system of claim 1, wherein each tabular dataset of the one or more tabular datasets comprises data related to a same historical time period.

5. The system of claim 4, wherein pre-training the hierarchical set of encoder machine-learning models using self-supervised learning comprises training the hierarchical set of encoder machine learning models to generate one or more elements of one or more second tabular datasets that comprise data related to a next historical time period.

6. The system of claim 1, wherein the one or more tabular datasets comprises a plurality of tabular datasets and the hierarchical set of encoder machine learning models comprises:
a plurality of first layer encoder machine learning models configured to generate, for each tabular dataset in the plurality of tabular datasets, one or more intermediate token that represents that tabular dataset; and
a second layer encoder machine learning model that is configured to generate the token from the intermediate tokens generated by the plurality of first layer encoder machine learning models.

7. The system of claim 6, wherein the plurality of first layer encoder machine learning models comprises, for each different type of tabular dataset in the plurality of tabular datasets, a first layer encoder machine learning model that is configured to generate the one or more intermediate token for each tabular dataset in the plurality of tabular datasets of that type.

8. The system of claim 6, wherein each tabular dataset of the plurality of tabular datasets comprises data related to a same historical time period, the historical time period is sub-divided into a plurality of sub-time periods, and the one or more intermediate token that represents a tabular dataset comprises an intermediate token for each of the plurality of sub-time periods that represents data in the tabular dataset related to that sub-time period.

9. The system of claim 8, wherein the historical time period is a 12-month period, and the plurality of sub-time periods comprises a sub-time period for each month of the 12-month period.

10. The system of claim 6, wherein each intermediate token is a same size.

11. The system of claim 6, wherein at least one first layer encoder machine learning model of the plurality of first layer encoder machine learning models comprises a multi-layer perceptron neural network.

12. The system of claim 6, wherein at least one first layer encoder machine learning model of the plurality of first layer encoder machine learning models comprises an encoder-only transformer model.

13. The system of claim 1, wherein the token is a multi-element vector.

14. The system of claim 13, wherein each element of the multi-element vector is a floating-point number.

15. The system of claim 13, wherein the multi-element vector comprises 128 elements.

16. The system of claim 1, wherein each tabular dataset of the one or more tabular datasets comprises time series data.

17. The system of claim 1, wherein at least one of the one or more prediction task comprises predicting a future event.

18. The system of claim 1, wherein the prediction head for at least one of the one or more prediction task comprises a multi-layer perceptron neural network.

19. A method for performing one or more prediction task, the method executed in a computing environment comprising at least one processor, the method comprising:
receiving a hierarchical set of encoder machine learning models configured to convert one or more tabular datasets into a token that represents the one or more tabular datasets;
pre-training the hierarchical set of encoder machine learning models using self-supervised learning to generate a pre-trained hierarchical set of encoder machine learning models;
fine-tuning a predictive model to perform the one or more prediction task using supervised learning, the predictive model comprising a prediction head for each of the one or more prediction task, each prediction head configured to generate a prediction for the corresponding prediction task based on the token generated by the pre-trained hierarchical set of encoder machine learning models; and
processing a plurality of new tabular datasets using the fine-tuned predictive model to generate a prediction for the one or more prediction task.

20. A non-transitory computer readable medium storing computer executable instructions which, when executed by at least one computer processor, cause the at least one computer processor to carry out a method for performing one or more prediction task, the method comprising:
receiving a hierarchical set of encoder machine learning models configured to convert one or more tabular datasets into a token that represents the one or more tabular datasets;
pre-training the hierarchical set of encoder machine learning models using self-supervised learning to generate a pre-trained hierarchical set of encoder machine learning models;
fine-tuning a predictive model to perform the one or more prediction task using supervised learning, the predictive model comprising a prediction head for each of the one or more prediction task, each prediction head configured to generate a prediction for the corresponding prediction task based on the token generated by the pre-trained hierarchical set of encoder machine learning models; and
processing a plurality of new tabular datasets using the fine-tuned predictive model to generate a prediction for the one or more prediction task.
